(19) United States
(12) Patent Application Publication
(10) Pub. No.: US 2025/0103042 A1
(43) Pub. Date: Mar. 27, 2025

(54) METHOD AND APPARATUS, ELECTRONIC DEVICE, AND STORAGE MEDIUM FOR TASK PROCESSING

(71) Applicant: Beijing Youzhuju Network Technology Co., Ltd., Beijing (CN)

(72) Inventors: Qiusi WANG, Beijing (CN); Lei YOU, Beijing (CN); Yi REN, Beijing (CN); Sai MA, Beijing (CN); Weizhi LIU, Beijing (CN); Hongxiang SHU, Beijing (CN)

(21) Appl. No.: 18/974,626

(22) Filed: Dec. 9, 2024

(30) Foreign Application Priority Data
Jan. 29, 2024 (CN) 202410123765.8

(51) Int. Cl. G05B 23/02

(52) U.S. Cl. CPC G05B 23/0286

(57) ABSTRACT

Embodiments of the present disclosure provide a robot dispatching method and apparatus, an electronic device, and a storage medium. The method includes: displaying at least one dispatchable robot available for switching in response to a robot switching instruction; and determining a target robot in response to a trigger operation for the at least one dispatchable robot, and sending robot information of the target robot to a dispatching system, so that the dispatching system associates a pending task associated with an abnormal robot with the target robot. According to the technical solutions of the embodiments of the present disclosure, an effect of switching to another robot to resume an associated task based on one-click operation is achieved, which in turn improves the universality and efficiency of a robot switching operation.

### CROSS-REFERENCE TO RELATED APPLICATION(S)

This application claims priority to Chinese Application No. 202410123765.8 filed Jan. 29, 2024, the disclosure of which is incorporated herein by reference in its entirety.

### FIELD

Embodiments of the present disclosure relate to robot application technologies, and in particular, to a robot dispatching method, apparatus, an electronic device, and a storage medium.

### BACKGROUND

During long-term operation, there may be an abnormality in a robot due to its own equipment, an external cause, or other causes. In the case of the abnormality, the robot may not be able to continue a task.

In related art, generally, a technician arrives at a site of the abnormal robot and migrates a task associated with the abnormal robot to another robot by means of manual recovery, so that the task can be resumed.

However, abnormality-related robot switchover based on the above method involves a complicated switchover process, which is laborious, time-consuming, and inefficient. In addition, a high level of expertise is required for users. For a user who has no experience in robot operation, it may be impossible to complete an abnormality-related robot switchover operation, which causes certain professional limitations and a problem of high robot operation and maintenance costs.

### SUMMARY

The embodiments of the present disclosure provides a robot dispatching method, apparatus, an electronic device, and a storage medium, in order to achieve an effect of switching to another robot to resume an associated task based on one-click operation, which in turn improves the universality and efficiency of a robot switching operation.

According to a first aspect, an embodiment of the present disclosure provides a robot dispatching method. The method includes:

displaying at least one dispatchable robot available for switching in response to a robot switching instruction; and
determining a target robot in response to a trigger operation for the at least one dispatchable robot, and sending robot information of the target robot to a dispatching system, so that the dispatching system associates a pending task associated with an abnormal robot with the target robot.

According to a second aspect, an embodiment of the present disclosure further provides a robot dispatching apparatus. The apparatus includes:

a robot display module configured to display at least one dispatchable robot available for switching in response to a robot switching instruction; and
a robot determining module configured to determine a target robot in response to a trigger operation for the at least one dispatchable robot, and send robot information of the target robot to a dispatching system, so that the dispatching system associates a pending task associated with an abnormal robot with the target robot.

According to a third aspect, an embodiment of the present disclosure further provides an electronic device. The electronic device includes:

one or more processors; and
a storage apparatus configured to store one or more programs, where
the one or more programs, which cause the one or more processors to implement the robot dispatching method described in any one of the embodiments of the present disclosure when executed by the one or more processors.

According to a fourth aspect, an embodiment of the present disclosure further provides a storage medium containing computer-executable instructions, where the computer-executable instructions are used to perform the robot dispatching method described in any one of the embodiments of the present disclosure when executed by a computer processor.

According to the technical solution of the embodiment of the present disclosure, the at least one dispatchable robot available for switching is displayed in response to the robot switching instruction. Further, the target robot is determined in response to the trigger operation for the at least one dispatchable robot, and the robot information of the target robot is sent to the dispatching system, so that the dispatching system associates a pending task associated with an abnormal robot with the target robot. Therefore, the technical problems of the related art in which a robot switching process requires a high-level of expertise and is laborious and time-consuming are solved. The effect of switching to another robot to resume the associated task based on one-click operation is achieved, which in turn improves the universality and efficiency of the robot switching operation. Moreover, the effect of improving abnormality response efficiency and abnormality recovery efficiency on the basis of reducing operation and maintenance costs is achieved.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a robot dispatching method according to an embodiment of the present disclosure;

FIG. 2 is a schematic flowchart of another robot dispatching method according to an embodiment of the present disclosure;

FIG. 3 is a schematic flowchart of another robot dispatching method according to an embodiment of the present disclosure;

FIG. 4 is a schematic flowchart of a robot dispatching method according to an embodiment of the present disclosure;

FIG. 5 is a schematic diagram of a structure of a robot dispatching apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Before the technical solutions are described, an exemplary description may be given to the application scenario. The technical solutions can be applied to any scenario where robot switching is needed. For example, when a robot performs a task in a target area (e.g., a hotel or an office building), there may be an abnormality in the robot due to its own equipment, an external cause, or other causes. In the case of the abnormality, the robot may not be able to continue a task. In this case, in order to ensure the continuity of the task, generally, a technician arrives at a site of the abnormal robot and migrates a task associated with the abnormal robot to another robot by means of manual recovery, so that the task can be resumed. However, abnormality-related robot switchover based on the above method involves a complicated switchover process, which is laborious, time-consuming, and inefficient. In addition, a high level of expertise is required for users. It may be impossible for a user (e.g., hotel staff or office workers) who has no experience in robot operation to complete an abnormality-related robot switchover operation, which causes certain professional limitations and a problem of high robot operation and maintenance costs.

In this case, based on the technical solutions of the embodiments of the present disclosure, in the case that an abnormal robot is determined, robot information of the abnormal robot may be displayed on a display interface of an administration console. Further, when a trigger operation for the robot information is detected, a robot switching procedure can be automatically initiated, and a process of migrating a pending task from the abnormal robot to a target robot for switching can be finally completed. That is, a pending task that is associated with the abnormal robot is associated with the target robot, so that the target robot resumes the pending task that is associated with the abnormal robot. Thus, an effect of switching to another robot to resume an associated task based on one-click operation is achieved, which in turn improves the universality and efficiency of a robot switching operation, and an effect of improving abnormality response efficiency and abnormality recovery efficiency is achieved in addition to reducing operation and maintenance costs.

FIG. 1 is a schematic flowchart of a robot dispatching method according to an embodiment of the present disclosure. This embodiment of the present disclosure is applicable to a scenario where a pending task that is associated with an abnormal robot is migrated to another robot in the case of the abnormal robot. The method may be performed by a robot dispatching apparatus. The apparatus may be implemented in the form of software and/or hardware. Optionally, the apparatus may be implemented by an electronic device, which may be a mobile terminal, a PC, a server, or the like.

As shown in FIG. 1, the method of this embodiment may specifically include the following steps.

S110: Display at least one dispatchable robot available for switching in response to a robot switching instruction.

In this embodiment, the robot switching instruction may be understood as a segment of program code, which may be configured to trigger the execution of the robot switching procedure. It can be understood that during the actual operation of a robot, some faults that cannot be quickly troubleshot may occur, such as sensor failure, wheel damage, body fracture, or false wire connection of hardware devices. As a result, the robot may be unable to continue performing the current task. In this case, in order to continue performing the current task and subsequent tasks received by the robot, an instruction may be sent to a robot dispatching system, so that the robot dispatching system may determine a dispatchable robot based on the instruction. The instruction sent to the robot dispatching system may be used as the robot switching instruction. The dispatchable robot may be understood as a robot that can be currently dispatched. The dispatchable robot may also be understood as a robot that is currently in an idle operating state and can perform the task.

Generally, for a target area, a plurality of robots may be used to perform corresponding tasks in the target area. In order to manage these robots in a centralized manner, an administration console, a dispatching system, and a task system may be set up in a cloud. Further, based on the systems set up in the cloud, a task may be assigned to each robot, a state of the robot may be detected, and the robot may be dispatched. In practical application, when it is determined that a robot switching condition is currently met, for example, there is an abnormality in any robot associated with the cloud, the robot switching instruction may be sent to the dispatching system, so that the dispatching system, upon reception of the instruction, may determine and display the at least one dispatchable robot available for switching. It should be noted that when the at least one dispatchable robot is displayed, robot information of the at least one dispatchable robot may be displayed, or other visual information of the at least one dispatchable robot may be displayed, etc., which is not specifically limited in the embodiments of the present disclosure.

Optionally, the displaying at least one dispatchable robot available for switching in response to a robot switching instruction includes: sending the robot switching instruction to the dispatching system, so that the dispatching system obtains a current state of at least one robot based on the robot switching instruction, and uses a robot whose current state is consistent with a preset state as the dispatchable robot; and receiving robot information of the dispatchable robot sent by the dispatching system, and displaying the robot information of the at least one dispatchable robot available for switching on a display interface.

In this embodiment, the dispatching system may be understood as a system for robot dispatching and management. The dispatching system may be configured to reasonably arrange a plurality of associated robots to improve the overall task performing efficiency. The current state may be understood as a state of a corresponding robot at a current moment. The current state may include a plurality of states. Optionally, the current state may include an idle state, an occupied state, and/or an unavailable state, etc. The preset state may be any state that can represent that a robot can be dispatched. Optionally, the preset state may be the idle state. It should be noted that the preset state may match the robot switching instruction. The robot information may be understood as information representing a basic situation of the robot. The robot information may include a plurality of types of information associated with the robot. Optionally, the robot information may include a robot identifier, robot positioning information, a task associated with the robot, a task state of each task, and a robot state (e.g., abnormal or normal), etc.

In practical application, when it is determined that the robot switching condition is currently met, the robot switching instruction may be generated based on the administration console, and response may be made to the instruction to send the generated instruction to the dispatching system. Further, upon reception of the instruction, the dispatching system may, based on the instruction, obtain a current state of at least one robot in communication with the dispatching system, and the preset state. Thereafter, for each robot, a current state of a current robot may be matched with the preset state, and when it is determined that the current state of the current robot is consistent with the preset state, the current robot may be determined as the dispatchable robot. Thereafter, after the at least one dispatchable robot is determined, corresponding robot information may be obtained based on robot identifiers of the dispatchable robots, and robot information of the dispatchable robots may be obtained. Further, the robot information of the dispatchable robots may be sent to the administration console based on the dispatching system, so as to display the robot information of the at least one dispatchable robot available for switching based on a display interface of the administration console. An advantage of such setup is that: an effect of quickly determining the dispatchable robot is achieved, and the intelligence of the dispatching system is improved. The display of the robot information of the dispatchable robot provides an interaction entry for the user, and then the robot switching procedure can be completed through a simple interface interaction operation.

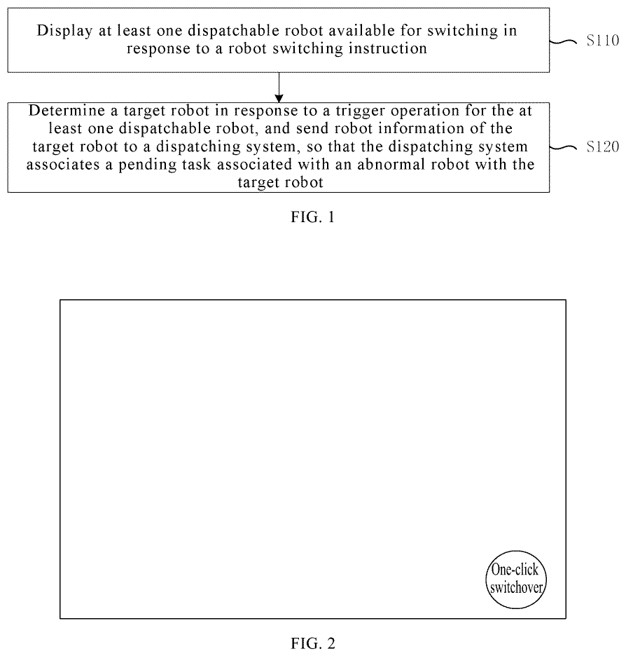

For example, FIG. 2 is a schematic diagram of a robot information display interface. As shown in FIG. 2, the display interface may include a “one-click switchover” control. When a trigger operation for the control is detected, the robot switching instruction may be generated, and the execution of an abnormality-related robot switchover procedure may be triggered.

S120: Determine a target robot in response to a trigger operation for the at least one dispatchable robot, and send robot information of the target robot to the dispatching system, so that the dispatching system associates, with the target robot, a pending task that is associated with an abnormal robot.

In this embodiment, when the at least one dispatchable robot available for switching is displayed, selection may be made from the displayed at least one dispatchable robot based on the trigger operation, so as to determine the target robot based on the trigger operation. The trigger operation may be an operation that triggers robot selection. Optionally, the trigger operation may include at least one of the following: trigger of a robot selection control; and audio information that includes a wake-up word associated with robot selection, etc. For example, the robot selection control may be preset, and the dispatchable robot may be displayed together with a corresponding robot selection control. Further, when a trigger operation for any robot selection control is detected, response may be made to the trigger operation, and a dispatchable robot corresponding to the robot selection control may be used as the target robot.

In this embodiment, the abnormal robot may be understood as a robot that is unable to operate normally due to a fault. The pending task may be understood as a pending task by the abnormal robot. The pending task may also be understood as a task that has not been completed by the abnormal robot.

In practical application, after the at least one dispatchable robot is displayed on the display interface, when a trigger operation for any dispatchable robot is detected, the dispatchable robot may be used as the target robot. Further, the robot information of the target robot may be sent to the dispatching system, so that the dispatching system associates, with the target robot, a pre-obtained task to be handled that is associated with the abnormal robot, in order for the target robot to perform the associated pending task.

It should be noted that, in the case that the abnormal robot is determined, robot information of the abnormal robot may be sent to the dispatching system, so that the dispatching system obtains the pending task that is associated with the abnormal robot based on the robot information. Further, a binding relationship between the abnormal robot and the pending task may be released, so that the pending task is cleared from a task performing queue of the abnormal robot.

It should be noted that when obtaining a current state of each robot, in order to make an obtained current state be the latest state, the state of the robot may be updated in time. On this basis, after the target robot is determined, the target robot may be marked as occupied based on the dispatching system, and then the target robot is marked as dispatchable after receiving that the target robot has completed a task.

In this embodiment, the occupied state may be understood as a non-idle state. The occupied state may be used to indicate that a robot is currently being occupied, that is, the robot is currently performing a task. The dispatchable state may be understood as an idle state, and may be used to indicate that the robot can be currently dispatched.

In practical application, after the target robot is determined, the robot information of the target robot may be sent to the dispatching system, so that the dispatching system determines the target robot based on the robot information, and marks the target robot as occupied. In this case, a current state of the target robot is the occupied state. Further, when the target robot has completed all pending tasks, a task completion instruction may be sent to the dispatching system. Furthermore, after receiving the task completion instruction sent by the target robot, the dispatching system may re-locate the target robot and mark the target robot as dispatchable. In this case, the current state of the target robot is the dispatchable state.

According to the technical solution of this embodiment of the present disclosure, the at least one dispatchable robot available for switching is displayed in response to the robot switching instruction. Further, the target robot is determined in response to the trigger operation for the at least one dispatchable robot, and the robot information of the target robot is sent to the dispatching system, so that the dispatching system associates the pending task associated with the abnormal robot with the target robot. Therefore, the technical problems of the related art in which a robot switching process requires a high-level of expertise and is laborious and time-consuming are solved. The effect of switching to another robot to resume the associated task based on one-click operation is achieved, which in turn improves the universality and efficiency of the robot switching operation. Moreover, the effect of improving abnormality response efficiency and abnormality recovery efficiency on the basis of reducing operation and maintenance costs is achieved.

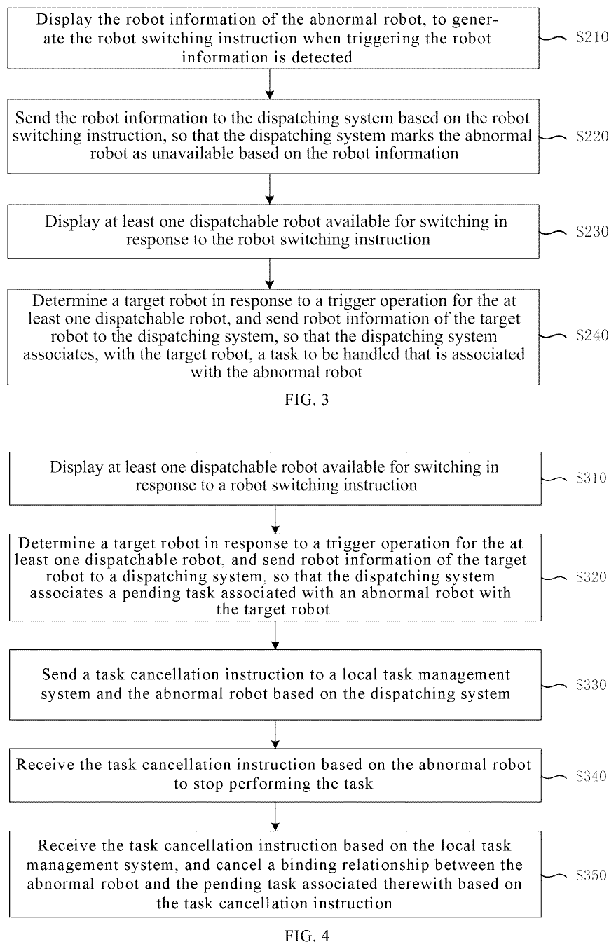

FIG. 3 is a schematic flowchart of another robot dispatching method according to an embodiment of the present disclosure. According to the technical solution of this embodiment based on the above embodiment, the robot information of the abnormal robot is displayed, to generate the robot switching instruction when it is detected that the robot information is triggered. Further, the robot information may be sent to the dispatching system based on the robot switching instruction, so that the dispatching system marks the abnormal robot as unavailable based on the robot information. For a specific implementation, reference may be made to the description of this embodiment. Details about technical features that are the same as or similar to those in the above embodiment are not described herein again.

As shown in FIG. 3, the method of this embodiment may specifically comprise the following steps.

S210: Display the robot information of the abnormal robot, to generate the robot switching instruction when triggering the robot information is detected.

In practical application, when any robot is detected to have a fault and is unable to perform a task, the robot may be determined as the abnormal robot. Further, the robot information of the abnormal robot may be obtained and displayed on the display interface, so that the user can be aware of the abnormal robot in time. Thereafter, in order to ensure that the pending task that is associated with the abnormal robot can be resumed, the abnormal robot may be switched to another robot to continue with the operation. In this case, the robot information of the abnormal robot displayed on the display interface may be triggered. Furthermore, when it is detected that the robot information is triggered, the robot switching instruction may be generated, and the execution of the robot switching procedure may be triggered based on the robot switching instruction.

S220: Send the robot information to the dispatching system based on the robot switching instruction, so that the dispatching system marks the abnormal robot as unavailable based on the robot information.

In this embodiment, the unavailable state may be used to indicate that a robot is currently unable to be used or perform a task.

In practical application, after the robot switching instruction is generated, it may be determined that the robot switching procedure is initiated. In this case, in order to ensure that the task system does not assign tasks to the abnormal robot anymore subsequently, the robot information of the abnormal robot may be sent to the dispatching system, so that the dispatching system determines the abnormal robot based on the robot information. Further, the abnormal robot may be marked as unavailable based on the dispatching system. In this case, a current state of the abnormal robot is the unavailable state.

S230: Display at least one dispatchable robot available for switching in response to the robot switching instruction.

S240: Determine a target robot in response to a trigger operation for the at least one dispatchable robot, and send robot information of the target robot to the dispatching system, so that the dispatching system associates a pending task associated with the abnormal robot with the target robot.

It should be noted that in order to ensure the continuity of a task, the task may be resumed from a breakpoint to ensure smooth completion of the task. Therefore, in the case that the abnormal robot is determined, in order to ensure the continuity of the pending task that is associated with the abnormal robot and to improve the efficiency of performing the pending task, a task shifting location for which the target robot should depart may be determined, so as to implement task shift between the target robot and the abnormal robot at the task shifting location.

On this basis, based on the above technical solutions, the method further includes: triggering selection of a takeover location on a display interface, so that the target robot and the abnormal robot perform a shift of the pending task at the takeover location.

In this embodiment, the takeover location may be understood as a robot takeover location. The takeover location may be any location associated with the abnormal robot. Optionally, the takeover location may be a collection location, a delivery location, any location on a transport path, or a location relatively close to the abnormal robot. It should be noted that a task performed by the robot may include a goods delivery task. For the goods delivery task, the robot may collect goods from a collection point and then transport the goods to a delivery point according to a preset delivery path. Therefore, in the case that the abnormal robot is detected, the collection location, the delivery location, and any location on the transport path may be used as a candidate takeover location.

In practical application, when the abnormal robot is determined, the at least one candidate takeover location may be determined based on positioning information of the abnormal robot and the pending task that is associated with the abnormal robot, and the at least one candidate takeover location may be displayed on the display interface, so that the takeover location may be selected by a trigger operation. Further, when a selection trigger operation for any candidate takeover location is detected, the candidate takeover location may be used as the takeover location. Further, the target robot and the abnormal robot may perform the shift of the pending task at the takeover location. That is, the target robot may start to perform the pending task at the takeover location.

It should be noted that, in order to enable the target robot and the abnormal robot to perform the shift of the pending task at the takeover location, the target robot and the abnormal robot may receive the takeover location, or receive an instruction including the takeover location. Further, the target robot and the abnormal robot may move to the takeover location and perform the shift of the pending task.

On this basis, after the determining a target robot, the method further includes: sending the takeover location to the dispatching system, so that the dispatching system generates a takeover instruction based on the takeover location, and sends the takeover instruction to the abnormal robot and the target robot, so that the target robot and the abnormal robot move to the takeover location to perform the shift of the pending task.

In this embodiment, the takeover instruction may be understood as a segment of program code, which may be used to instruct the robots to move to the takeover location. The takeover instruction may include a plurality of types of information associated with a takeover process. Optionally, the takeover instruction may include the takeover location.

In practical application, after the takeover location is determined, the takeover location may be sent to the dispatching system, so that the dispatching system generates the takeover instruction based on the takeover location, and the takeover instruction is sent to the abnormal robot and the target robot based on the dispatching system. Further, after receiving the takeover instruction, the abnormal robot and the target robot may parse the takeover instruction to obtain the takeover location. Thereafter, the abnormal robot and the target robot may move to the takeover location, and perform the shift of the pending task at the takeover location.

For example, exemplary description will be made for the technical solution provided in the embodiment of the present disclosure by taking the abnormal robot as a robot A and the target robot as a robot B as an example. First, robot information of the robots and a candidate takeover location are displayed based on the display interface of the administration console; next, selection of a takeover location P and robot information of the robot A may be triggered, and the robot information and the takeover location may be sent to the dispatching system. Then, the robot A is marked as non-dispatchable based on the dispatching system, so that the robot A cannot be assigned a task by the dispatching system. Thereafter, a task cancellation instruction is sent to a robot local task management system based on the dispatching system, so that the robot local task management system cancels a binding relationship between the robot A and a pending task that is associated therewith based on the task cancellation instruction, and cancels a local task of the robot A based on the task cancellation instruction. A task state of the pending task that is associated with the robot A is changed based on the robot local task management system. Thereafter, the robot B suitable for succeeding the task is redetermined according to a dispatching rule based on the dispatching system, and the robot B is marked as occupied. Thereafter, a pending task that is associated with the robot A is associated with the robot B based on the dispatching system, and a local task is distributed to the robot B, where the distributed local task includes: going to the takeover location P and performing the pending task that is associated with the robot A. Thereafter, after receiving a task completion instruction sent by the robot local task management system, the dispatching system may mark the robot B as dispatchable so that the robot B may continue to be dispatched. After receiving an instruction of maintenance completion for the robot A, the dispatching system may mark the robot A as dispatchable.

According to the technical solution of this embodiment of the present disclosure, the robot information of the abnormal robot is displayed, to generate the robot switching instruction when it is detected that the robot information is triggered, and then, the robot information is sent to the dispatching system based on the robot switching instruction, so that the dispatching system marks the abnormal robot as unavailable based on the robot information. Further, the at least one dispatchable robot available for switching is displayed in response to the robot switching instruction, thereafter, the target robot is determined in response to the trigger operation for the at least one dispatchable robot, and the robot information of the target robot is sent to the dispatching system, so that the dispatching system associates the pending task associated with the abnormal robot with the target robot. The effect of switching to another robot to resume the associated task based on one-click operation in the case of the abnormal robot is achieved, which involves wider applicability. Moreover, the intelligence of the dispatching system is enhanced.

FIG. 4 is a schematic flowchart of another robot dispatching method according to an embodiment of the present disclosure. On the basis of the above embodiment and according to the technical solution of this embodiment, the task cancellation instruction is sent to the local task management system and the abnormal robot based on the dispatching system, and further, the task cancellation instruction is received based on the abnormal robot, to stop performing the task; and the task cancellation instruction is received based on the local task management system, and the binding relationship between the abnormal robot and the pending task associated therewith is canceled based on the task cancellation instruction. For a specific implementation, reference may be made to the description of this embodiment. Details about technical features that are the same as or similar to those in the above embodiment are not described herein again.

As shown in FIG. 4, the method of this embodiment may include the following steps.

S310: Display at least one dispatchable robot available for switching in response to a robot switching instruction.

S320: Determine a target robot in response to a trigger operation for the at least one dispatchable robot, and send robot information of the target robot to the dispatching system, so that the dispatching system associates, with the target robot, a pending task that is associated with the abnormal robot.

S330: Send, based on the dispatching system, the task cancellation instruction to the local task management system and the abnormal robot.

In this embodiment, the local task management system may be understood as a task management system set up on a local side, which may be configured to manage a task to be performed by a robot. It should be noted that advantages of setting up the local task management system are that: during the process of the robot performing the task in the target area, the robot may not be able to keep connected to a network at all times, that is, the robot may not be able to interact with the cloud at all times. In this case, the local task management system may be set up on the local side, and further, all tasks sent from the cloud to the robot may be cached based on the local task management system to ensure that the robot can continue performing a corresponding task when it is not connected to the network; in addition, a task associated with a corresponding robot can also be effectively managed based on a task orchestrating logic and an operation logic that are pre-deployed in the local task management system. Optionally, the local task management system may be a system set up in the robot, or an interface integrated in the robot, so that the local task management system may be called based on the interface.

In this embodiment, the task cancellation instruction may be understood as a segment of program code, which may be used to instruct an instruction receiving end to cancel the corresponding task.

In practical application, in the case where the abnormal robot is determined, in order to prevent the abnormal robot from continuing performing the associated task to be handled, and to enable the local task management system to update task management information in time, after receiving the robot information of the abnormal robot, the dispatching system may generate the task cancellation instruction based on the robot information. Further, the task cancellation instruction is sent to the local task management system and the abnormal robot based on the dispatching system, so that the local task management system and the abnormal robot may perform corresponding operations based on the task cancellation instruction.

S340: Receive, based on the abnormal robot, the task cancellation instruction, to stop performing the task.

In practical application, when the abnormal robot receives the task cancellation instruction, the abnormal robot may be enabled to stop performing the task based on the task cancellation instruction, so that the abnormal robot is prevented from continuing to perform all tasks to be handled that are associated therewith.

S350: Receive, based on the local task management system, the task cancellation instruction, and cancel the binding relationship between the abnormal robot and the pending task associated therewith based on the task cancellation instruction.

It should be noted that in order to more effectively manage a robot and a task associated with the robot, when the local task management system receives a pending task that is sent to the robot from the cloud, a target robot that can perform the pending task may be determined based on a pre-deployed task orchestrating logic. Further, the received pending task may be associated with the corresponding target robot to establish a binding relationship between the pending task and the robot.

In practical application, after the task cancellation instruction is received by the local task management system, the task cancellation instruction may be parsed, and then the abnormal robot is determined. Further, the pending task associated with the abnormal robot may be determined, and the binding relationship between the abnormal robot and the pending task that is associated therewith may be canceled.

It should be noted that the reception of the task cancellation instruction by the local task management system indicates that there is an abnormal robot currently. In this case, in order to better manage a received task, a task state of the pending task that is associated with the abnormal robot may further be updated. Then, the corresponding task may be handled based on an updated task state.

On this basis, after the task cancellation instruction is received based on the local task management system, the method further includes: determining transfer information of the pending task based on the task state of the pending task associated with the abnormal robot, so as to associate the pending task with the target robot based on the transfer information.

In this embodiment, the task state may be understood as information that represents a task performing situation. The task state may be any state associated with the task performing situation. Optionally, the task state may be a non-suspended state or a suspended state. The transfer information may be understood as information that represents a flow and transfer situation of the task. The transfer information may be used to represent a transfer situation of the task being performed. It can be understood that for the pending task associated with the abnormal robot, in the case that the target robot is determined, in order to enable the target robot to resume the pending task, the target robot needs to be associated with the pending task. Therefore, the transfer information of the pending task may be that the pending task is to be associated with the target robot or the state remains unchanged.

In practical application, after the task cancellation instruction is received by the local task management system, the abnormal robot may be determined based on the task cancellation instruction, and then the pending task associated with the abnormal robot may be determined. Further, the task state of the pending task may be determined. Furthermore, the transfer information of the pending task may be determined based on the task state of the pending task.

In this embodiment, the pending task may include at least two task state, and different task state may correspond to different transfer information. Description for each of these two task state may be provided below.

First: If the task state of the pending task is a non-suspended state, the transfer information is determined that the pending task is to be associated with the target robot.

In this embodiment, the non-suspended state may be used to indicate that a corresponding task is in an uncompleted and to-be-resumed state, that is, the task can be currently performed.

In practical application, if the task state of the pending task is the non-suspended state, it may be indicated that the pending task is currently in the uncompleted and to-be-resumed state. Further, in order to ensure that the pending task can be resumed, the transfer information of the pending task may be determined that the pending task is to be associated with the target robot. Furthermore, the pending task may be associated with the target robot based on the transfer information.

For example, assuming that task information of the pending task is: assigned to a robot, arrived at a collection point, collected by the robot, a delivery started, and arrived at a delivery point, it can be indicated that the task state of the pending task is the non-suspended state. In this case, the transfer information of the pending task may be determined that the pending task is to be associated with the target robot, and the task state of the pending task may be changed to a state of waiting for a robot to be assigned.

Second: If the task state of the pending task is a suspended state, the transfer information is determined that the state remains unchanged.

In this embodiment, the suspended state may be understood as a state in which a task object to be picked up that is associated with a corresponding task has timed out and has not been picked up. For example, the task object to be picked up may be goods, etc.

In practical application, if the task state of the pending task is the suspended state, it may be indicated that a task object to be picked up that corresponds to the pending task has timed out and has not been picked up. In this case, in order to ensure that the task object to be picked up that corresponds to the pending task is not lost, the transfer information of the pending task may be determined that the state remains unchanged.

For example, assuming that task information of the pending task includes: collected by a robot and timed out and not been picked up by a user, it can be indicated that the task state of the pending task is the suspended state. In this case, the transfer information of the pending task may be determined that the state remains unchanged.

It should be noted that advantages of having different task states correspond to different transfer information is that: the task performing efficiency of the pending task is improved. Moreover, it is ensured that the task object associated with the suspended task can be accurately picked up by the user.

According to the technical solution of the disclosed embodiment, the at least one dispatchable robot available for switching is displayed in response to the robot switching instruction; then, the target robot is determined in response to the trigger operation for the at least one dispatchable robot, and the robot information of the target robot is sent to the dispatching system, so that the dispatching system associates the pending task associated with the abnormal robot with the target robot; thereafter, the task cancellation instruction is sent to the local task management system and the abnormal robot based on the dispatching system, and further, the task cancellation instruction is received based on the abnormal robot, to stop performing the task; and the task cancellation instruction is received based on the local task management system, and the binding relationship between the abnormal robot and the pending task that is associated therewith is canceled based on the task cancellation instruction. Thus, the timely cancellation of the binding relationship between the abnormal robot and the task in the case of the abnormal robot is achieved, thereby preventing the task from being resumed.

FIG. 5 is a schematic diagram of a structure of a robot dispatching apparatus according to an embodiment of the present disclosure. As shown in FIG. 5, the apparatus includes: a robot display module 410 and a robot determining module 420.

The robot display module 410 is configured to display at least one dispatchable robot available for switching in response to a robot switching instruction; and the robot determining module 420 is configured to determine a target robot in response to a trigger operation for the at least one dispatchable robot, and send robot information of the target robot to a dispatching system, so that the dispatching system associates a pending task associated with an abnormal robot with the target robot.

On the basis of the above optional technical solutions, optionally, the apparatus further includes: an instruction generation module and an information sending module,

where the instruction generation module is configured to display robot information of the abnormal robot, to generate a robot switching instruction when it is detected that the robot information is triggered; and
the information sending module is configured to send the robot information to the dispatching system based on the robot switching instruction, so that the dispatching system marks the abnormal robot as unavailable based on the robot information.

On the basis of the above optional technical solutions, optionally, the apparatus further includes: a takeover location determining module,

where the takeover location determining module is configured to trigger selection of a takeover location on a display interface, so that the target robot and the abnormal robot perform a shift of the pending task at the takeover location.

On the basis of the above optional technical solutions, optionally, the apparatus further includes: an instruction sending module, a task performing stop module, and a binding relationship cancellation module,

where the instruction sending module is configured to send, based on the dispatching system, a task cancellation instruction to a local task management system and the abnormal robot;
the task performing stop module is configured to receive, based on the abnormal robot, the task cancellation instruction, to stop performing the task; and
the binding relationship cancellation module is configured to receive, based on the local task management system, the task cancellation instruction, and cancel a binding relationship between the abnormal robot and the pending task that is associated therewith based on the task cancellation instruction.

On the basis of the above optional technical solutions, optionally, the apparatus further includes: a transfer information determining module,

where the transfer information determining module is configured to determine transfer information of the pending task based on a task state of the pending task associated with the abnormal robot, to associate the pending task with the target robot based on the transfer information after the task cancellation instruction is received based on the local task management system.

On the basis of the above optional technical solutions, optionally, the transfer information determining module includes: a first transfer information determining unit and a second transfer information determining unit,

where the first transfer information determining unit is configured to, if the task state of the pending task is a non-suspended state, determine the transfer information that the pending task is to be associated with the target robot; or
the second transfer information determining unit is configured to, if the task state of the pending task is a suspended state, determining the transfer information that the state remains unchanged.

On the basis of the above optional technical solutions, optionally, the robot display module 410 includes: a state obtaining unit and a robot information display unit,

where the state obtaining unit is configured to send the robot switching instruction to the dispatching system, so that the dispatching system obtains a current state of at least one robot based on the robot switching instruction, and uses the robot whose current state is consistent with a preset state as the dispatchable robot; and
the robot information display unit is configured to receive robot information of the dispatchable robot sent by the dispatching system, and display, on the display interface, robot information of the at least one dispatchable robot available for switching.

On the basis of the above optional technical solutions, optionally, the apparatus further includes: a takeover location sending module,

where the takeover location sending module is configured to send the takeover location to the dispatching system after the target robot is determined, so that the dispatching system generates a takeover instruction based on the takeover location and sends the takeover instruction to the abnormal robot and the target robot, in order for the target robot and the abnormal robot to move to the takeover location to perform the shift of the pending task.

On the basis of the above optional technical solutions, optionally, the apparatus further includes: a state marking module,

where the state marking module is configured to, after the target robot is determined, mark, based on the dispatching system, the target robot as occupied, and mark the target robot as dispatchable after receiving that the target robot has completed a task.

According to the technical solution of this embodiment of the present disclosure, the at least one dispatchable robot available for switching is displayed in response to the robot switching instruction. Further, the target robot is determined in response to the trigger operation for the at least one dispatchable robot, and the robot information of the target robot is sent to the dispatching system, so that the dispatching system associates the pending task associated with the abnormal robot with the target robot. Therefore, the technical problems of the related art in which a robot switching process requires a high-level of expertise and is laborious and time-consuming are solved. The effect of switching to another robot to resume the associated task based on one-click operation is achieved, which in turn improves the universality and efficiency of the robot switching operation. Moreover, the effect of improving abnormality response efficiency and abnormality recovery efficiency on the basis of reducing operation and maintenance costs is achieved.

The robot dispatching apparatus according to an embodiment of the present disclosure can perform the robot dispatching method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

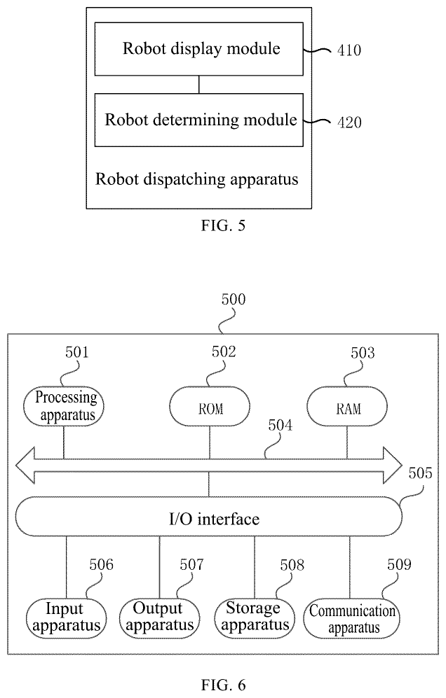

FIG. 6 is a schematic diagram of a structure of an electronic device according to an embodiment of the present disclosure. Reference is made to FIG. 6 below, which is a schematic diagram of a structure of an electronic device (such as a terminal device or a server in FIG. 6) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 6 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to an embodiment of the present disclosure and the robot dispatching method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the robot dispatching method according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: display at least one dispatchable robot available for switching in response to a robot switching instruction; and determine a target robot in response to a trigger operation for the at least one dispatchable robot, and send robot information of the target robot to a dispatching system, so that the dispatching system associates, with the target robot, a pending task that is associated with an abnormal robot.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A robot dispatching method, comprising:
displaying at least one dispatchable robot available for switching in response to a robot switching instruction; and
determining a target robot in response to a trigger operation for the at least one dispatchable robot, and sending robot information of the target robot to a dispatching system, so that the dispatching system associates a pending task associated with an abnormal robot with the target robot.

2. The method according to claim 1, wherein the method further comprises:
displaying robot information of the abnormal robot, to generate the robot switching instruction when triggering the robot information is detected; and
sending the robot information to the dispatching system based on the robot switching instruction, so that the dispatching system marks the abnormal robot as unavailable based on the robot information.

3. The method according to claim 2, wherein the method further comprises:
triggering selection of a takeover location on a display interface, so that the target robot and the abnormal robot perform a shift of the pending task at the takeover location.

4. The method according to claim 1, wherein the method further comprises:
sending a task cancellation instruction to a local task management system and the abnormal robot based on the dispatching system;
receiving the task cancellation instruction based on the abnormal robot to stop performing the task; and
receiving the task cancellation instruction based on the local task management system, and canceling a binding relationship between the abnormal robot and the pending task associated therewith based on the task cancellation instruction.

5. The method according to claim 4, wherein after the receiving the task cancellation instruction based on the local task management system, the method further comprises:
determining transfer information of the pending task based on a task state of the pending task that is associated with the abnormal robot to associate the pending task with the target robot based on the transfer information.

6. The method according to claim 5, wherein the determining transfer information of the pending task based on a task state of the pending task that is associated with the abnormal robot comprises:
when the task state of the pending task is a non-suspended state, determining that the transfer information is to be associated with the target robot; or
when the task state of the pending task is a suspended state, determining that the transfer information is that the state remains unchanged.

7. The method according to claim 1, wherein the displaying at least one dispatchable robot available for switching in response to a robot switching instruction comprises:
sending the robot switching instruction to the dispatching system, so that the dispatching system obtains a current state of at least one robot based on the robot switching instruction, and uses a robot whose current state is consistent with a preset state as the dispatchable robot; and
receiving the robot information of the dispatchable robot sent by the dispatching system, and displaying the robot information of the at least one dispatchable robot available for switching on a display interface.

8. The method according to claim 3, wherein after the determining a target robot, the method further comprises:
sending the takeover location to the dispatching system, so that the dispatching system generates a takeover instruction based on the takeover location, and sends the takeover instruction to the abnormal robot and the target robot, so that the target robot and the abnormal robot move to the takeover location to perform the shift of the pending task.

9. The method according to claim 1, wherein after the determining a target robot, the method further comprises:
marking the target robot as occupied based on the dispatching system, and marking the target robot as dispatchable after receiving that the target robot has completed the task.

10. An electronic device, comprising:
one or more processors; and
a storage apparatus configured to store one or more programs,
when executed by the one or more processors, the one or more programs cause the one or more processors to:
display at least one dispatchable robot available for switching in response to a robot switching instruction; and
determine a target robot in response to a trigger operation for the at least one dispatchable robot, and send robot information of the target robot to a dispatching system, so that the dispatching system associates a pending task associated with an abnormal robot with the target robot.

11. The electronic device according to claim 10, wherein the one or more programs cause the one or more processors to:
display robot information of the abnormal robot, to generate the robot switching instruction when triggering the robot information is detected; and
send the robot information to the dispatching system based on the robot switching instruction, so that the dispatching system marks the abnormal robot as unavailable based on the robot information.

12. The electronic device according to claim 11, wherein the one or more programs cause the one or more processors to:
trigger selection of a takeover location on a display interface, so that the target robot and the abnormal robot perform a shift of the pending task at the takeover location.

13. The electronic device according to claim 10, wherein the one or more programs cause the one or more processors to:
send a task cancellation instruction to a local task management system and the abnormal robot based on the dispatching system;
receive the task cancellation instruction based on the abnormal robot to stop performing the task; and
receive the task cancellation instruction based on the local task management system, and cancel a binding relationship between the abnormal robot and the pending task associated therewith based on the task cancellation instruction.

14. The electronic device according to claim 13, wherein the one or more programs cause the one or more processors to:
determine transfer information of the pending task based on a task state of the pending task that is associated with the abnormal robot to associate the pending task with the target robot based on the transfer information.

15. The electronic device according to claim 14, wherein the determining transfer information of the pending task based on a task state of the pending task that is associated with the abnormal robot comprises:
when the task state of the pending task is a non-suspended state, determining that the transfer information is to be associated with the target robot; or
when the task state of the pending task is a suspended state, determining that the transfer information is that the state remains unchanged.

16. The electronic device according to claim 10, wherein the displaying at least one dispatchable robot available for switching in response to a robot switching instruction comprises:
send the robot switching instruction to the dispatching system, so that the dispatching system obtains a current state of at least one robot based on the robot switching instruction, and uses a robot whose current state is consistent with a preset state as the dispatchable robot; and
receive the robot information of the dispatchable robot sent by the dispatching system, and displaying the robot information of the at least one dispatchable robot available for switching on a display interface.

17. The electronic device according to claim 12, wherein after the determining a target robot, the one or more programs cause the one or more processors to:
send the takeover location to the dispatching system, so that the dispatching system generates a takeover instruction based on the takeover location, and sends the takeover instruction to the abnormal robot and the target robot, so that the target robot and the abnormal robot move to the takeover location to perform the shift of the pending task.

18. The electronic device according to claim 10, wherein after the determining a target robot, the one or more programs cause the one or more processors to:
mark the target robot as occupied based on the dispatching system, and marking the target robot as dispatchable after receiving that the target robot has completed the task.

19. A non-transitory storage medium containing computer-executable instructions, wherein when executed by a computer processor, the computer-executable instructions cause the computer processor to:
display at least one dispatchable robot available for switching in response to a robot switching instruction; and
determine a target robot in response to a trigger operation for the at least one dispatchable robot, and sending robot information of the target robot to a dispatching system, so that the dispatching system associates a pending task associated with an abnormal robot with the target robot.

20. The non-transitory storage medium according to claim 19, wherein the one or more programs cause the one or more processors to:
display robot information of the abnormal robot, to generate the robot switching instruction when triggering the robot information is detected; and
send the robot information to the dispatching system based on the robot switching instruction, so that the dispatching system marks the abnormal robot as unavailable based on the robot information.
